(19) United States
(12) Patent Application Publication
(10) Pub. No.: US 2023/0295953 A1
(43) Pub. Date: Sep. 21, 2023

(54) SMART ASSEMBLY HANDLE MECHANISM

(71) Applicant: Gulesci Saffet, Gaziosmanpasa (TR)

(72) Inventor: Gulesci Saffet, Gaziosmanpasa (TR)

(21) Appl. No.: 18/013,562

(22) PCT Filed: Jul. 17, 2021
(86) PCT No.: PCT/TR2021/050738

§ 371 Date: Dec. 29, 2022

(30) Foreign Application Priority Data
Aug. 4, 2020 (TR) 2020/12215

(51) Int. Cl. E05B 3/06

(52) U.S. Cl. CPC E05B 3/065

(57) ABSTRACT

The present invention relates to a smart assembly handle mechanism which is for handle mechanisms of the doors in the furniture sector, eliminates the use of spacers such as nail, washers in the mechanism with the use of segment of the door handle, located on the motion shaft in the badge, ensures that the door handle is fixed as desired with the motion spring and spring cover in the inner badge and is able to return to its original state by making a springing movement with the movement spring after the opening process, provides easy assembly of the inner badge mechanism and the motion shaft to the door lock system, mainly consists of the following; drive shaft (1), cartridge (2), screw (3), badge ring (4), door handle (5), handle locking tab (6), door (7), lock (8), inner badge (9), motion spring (10), spring cover (11).

### FIELD OF THE INVENTION

The present invention relates to a smart assembly handle mechanism which is for handle mechanisms of the doors in the furniture sector, eliminates the use of spacers such as nail washers in the mechanism with the use of segment of the door handle, located on the motion shaft in the badge, ensures that the door handle is fixed as desired with the motion spring and spring cover in the inner badge and is able to return to its original state by making a springing movement with the movement spring after the opening process, provides easy assembly of the inner badge mechanism and the motion shaft to the door lock system.

### STATE OF THE ART

A door is a hinged (hinge assembly), sliding, or openable plate or compartment clearing with electronic equipment, which is passed when entering and leaving a place or a vehicle. Doors are architectural elements that are used in the someway in all cultures of the world; allow entry into buildings or changing places between rooms within the building.

Lock and counter system elements, which are widely used in the world, are the mechanisms located opposite each other on the door and the frame. Current door locks comprise bolt and latch elements for closing and locking the door. The lock is mounted corresponding the door frame and on the wing section. When the door is pushed, the latch enters the counter slot in the frame and the door is closed. In case the bolt is inserted into its slot in the frame by means of the key after the door is closed, the door will be locked. The key is required to be used so as to open the locked door, and the handle must be turned down so as to open the unlocked door.

This system which is widely used in the world is characterized by requiring a tool such as handle and knob etc. for opening the door. Similarly, it is necessary to open the slots in which the elements such as the handle and knob that enable the door to open and close are mounted. Opening these slots leads to a great loss of time and cost for door manufacturers. Door handles are placed on the door handle lock mechanism placed in the door slots.

The door handle is mounted to the lock mechanism with the help of a shaft in the door handle lock mechanism on the door. A badge is placed on the locking mechanism so as to cover the locking mechanism connection of the motion shaft and the door handle during connection and to provide an aesthetic appearance.

In the assembly of the door handle assembly to the lock mechanism of the door handle described above, production of parts such as nails and washers prolongs the assembly time in the production of the door handle mechanism. The extension in the assembly duration increases the production cost by reducing the number of production per unit time.

The door handle mechanism, which is mounted on the lock mechanism, stands at 90° horizontal plane with the spring mechanism in the lock mechanism, when the door handle is pulled down so as to open the door after the door is opened, it is restored at 90° horizontal plane by means of the spring mechanism in the door handle lock mechanism. However, the spring mechanism bends due to material fatigue caused by use over time and the door handle falls down.

As can be understood from the above-descriptions, it is clearly observed that there is a need for a second system or mechanism that allows the door handle to stop at 90° horizontal plane in the door handle mechanism mounted on the door lock mechanism, a mechanism by which the door handle mechanism may be easier to mount to the door lock mechanism.

### TECHNICAL PROBLEMS AIMED TO BE SOLVED WITH THE INVENTION

The present invention which relates to a smart assembly handle mechanism which is for handle mechanisms of the doors in the furniture sector, eliminates the use of spacers such as nail washers in the mechanism with the use of segment of the door handle, located on the motion shaft in the badge, ensures that the door handle is fixed as desired with the motion spring and spring cover in the inner badge and is able to return to its original state by making a springing movement with the movement spring after the opening process, provides easy assembly of the inner badge mechanism and the motion shaft to the door lock system, completely overcomes the disadvantages described above, and characterized in that; the smart assembly handle mechanism is presented in disassembled form, the structure of the smart assembly handle mechanism is simple, and the assembly of the smart assembly handle mechanism is easy.

Smart assembly handle mechanism is provided in disassembled form. The disassembled provision ensures that the assembly line is eliminated in production and the manufacturing cost is reduced. The disassembled packaging of the door handle mechanism related to the disassembled presentation also ensures that the package size is reduced. In this case, transportation costs are also reduced.

The door handle can be easily assembled by any user. The door handle can be easily mounted on the door lock mechanism by following the instructions of the door handle package.

Since the structure of the smart assembly arm mechanism is simple, this reduces the possibility of failure. It extends the economic life.

### DESCRIPTION OF THE FIGURES

FIG. 1 is a general view of the smart assembly handle mechanism.

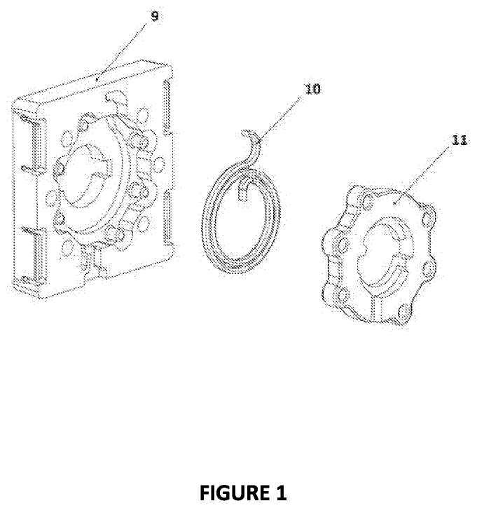

FIG. 2 is a general view of the smart assembly handle mechanism.

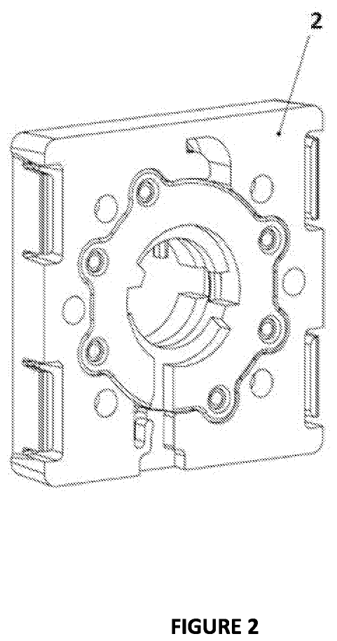

FIG. 3 is a general view of the smart assembly handle mechanism.

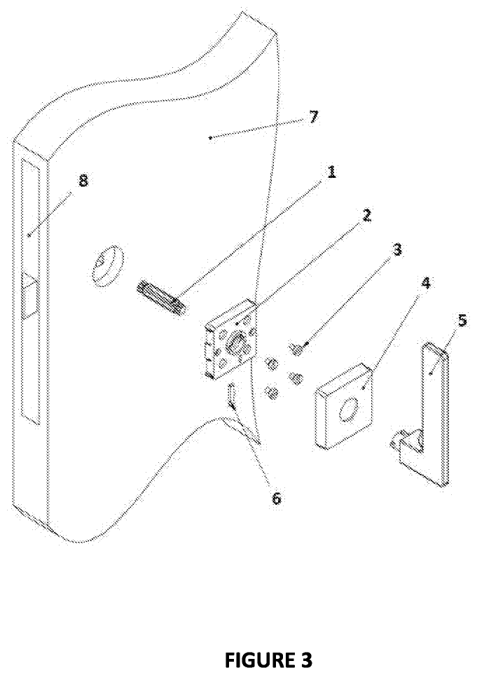

FIG. 4 is a detail view of the smart assembly handle mechanism.

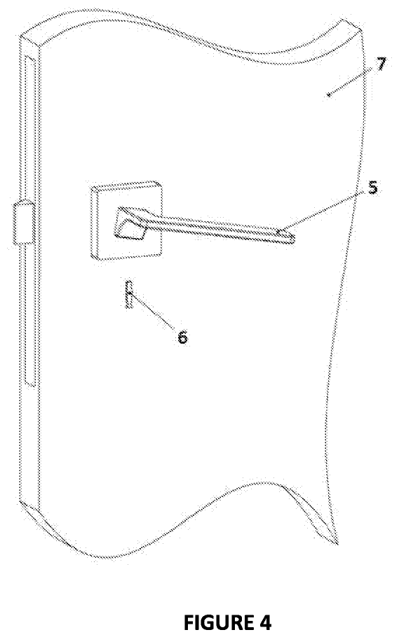

FIG. 5 is a detail view of the smart assembly handle mechanism.

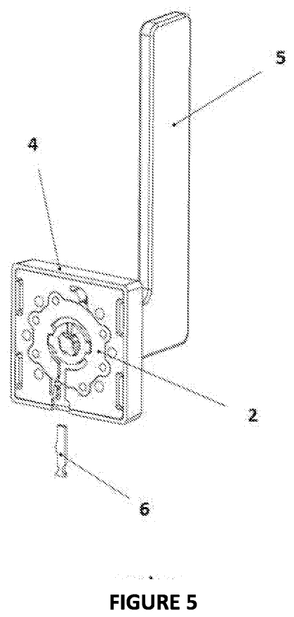

FIG. 6 is a detail view of the smart assembly handle mechanism.

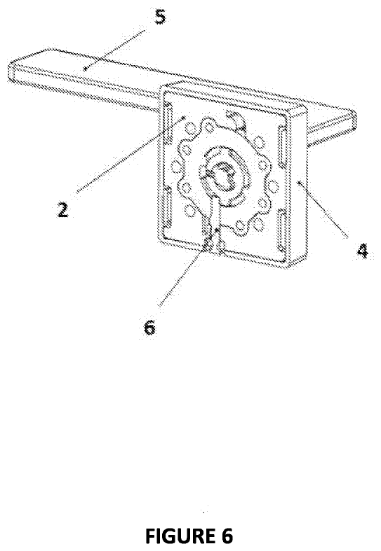

FIG. 7 is an assembly view of the smart assembly handle mechanism.

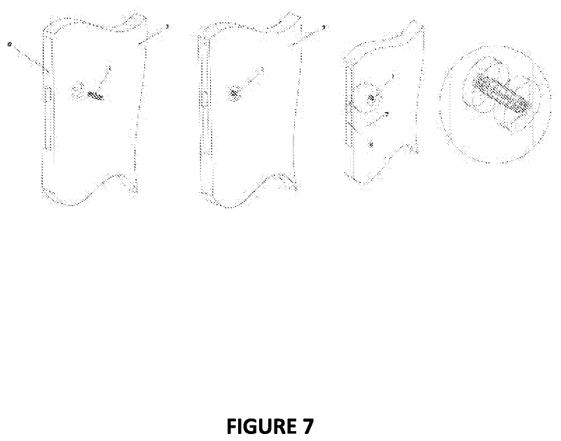

FIG. 8 is an assembly view of the smart assembly handle mechanism.

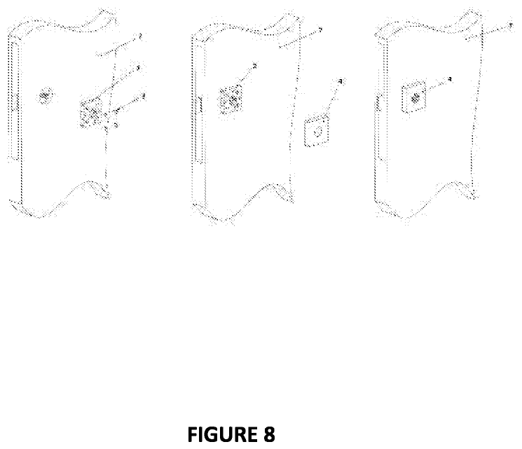

FIG. 9 is an assembly view of the smart assembly handle mechanism.

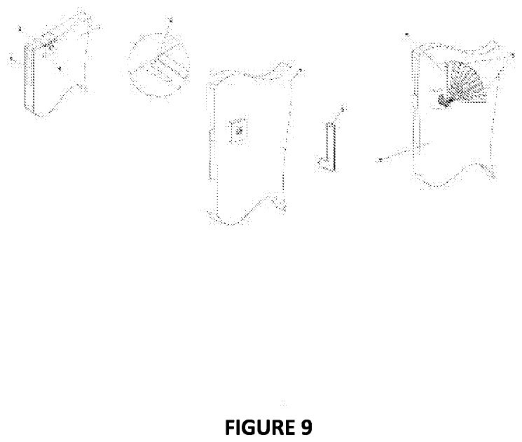

### DESCRIPTION OF THE REFERENCES

| NO | PART NAME |
|---|---|
| 1 | Motion shaft |
| 2 | Cartridge |
| 3 | Screw |
| 4 | Badge ring |
| 5 | Door Handle |
| 6 | Handle Locking Tab |
| 7 | Door |
| 8 | Lock |
| 9 | Inner Badge |
| 10 | Motion Spring |
| 11 | Spring Cover |

The present invention relates to a smart assembly handle mechanism which is for handle mechanisms of the, doors in the furniture sector, eliminates the use of spacers such as nail, washers in the mechanism with the use of segment of the door handle, located on the motion shaft in the badge, ensures that the door handle is fixed as desired with the motion spring and spring cover in the inner badge and is able to return to its original state by making a springing movement with the movement spring after the opening process, provides easy assembly of the inner badge mechanism and the motion shaft to the door lock system, mainly consists of the following; drive shaft (1), cartridge (2), screw (3), badge ring (4), door handle (5), handle locking tab (6), door (7), lock (8), inner badge (9), motion spring (10), spring cover (11).

### DESCRIPTION OF THE INVENTION

There is a motion shaft (1) in the smart assembly handle mechanism, which is the movement organ between the door handle (5) and the lock (8) and provides the movement of the tongue. Since the assembly of the door handle (5) is movable and provided by the end user, it provides the door handle (5) to be setup.

There is a cartridge (2) in the smart assembly handle mechanism, which supports the motion spring (10) and enables the door handle (5) to be mounted on the door (7).

There is a screw (3) in the smart assembly handle mechanism, which enables the cartridge (2) to be assembled on the door (7).

There is a badge ring (4) in the smart assembly handle mechanism, which ensures to hide the cartridge (2) and provides visuality on the door (7),

There is a door handle (5) in the smart assembly handle mechanism, that enables the door (7) to be opened by moving the lock (8) tongue.

There is a handle locking tab (6) in the smart assembly handle mechanism, which ensures that the door handle (5) is fixed in the installed position and cannot be removed.

There is an internal badge (9) in the smart assembly handle mechanism, which supports the movement spring (10) and enables the door handle to be supported.

There is a motion spring (10) in the smart assembly handle mechanism, which provides the pressure sensitivity and positioning of the door handle.

There is a spring cover (11) in the smart assembly handle mechanism, which provides fixation of the motion spring (10) and movement supporting and limitation to the door handle (5).

The operation of the invention; the motion shaft (1) is placed in the door lock (8). Then, the cartridge (2) is mounted to the door (7) with screws (3). The badge ring (4) is closed on the cartridge (2) until the tabs are locked. When the door handle (5) is in the vertical position, the cartridge (2) is pushed forward until it leans through its hole. After the door handle (5) leans on the cartridge (2), it is rotated 100 degrees to 110 degrees. The door handle locking tab (6), which is kept fixed at the desired degree, is driven in from the tab slot at the bottom of the cartridge (2) until it engages. The door handle (5) is released until it rests on the door handle locking tab (6), and the door handle (5) positioning is completed after the door handle locking tab (6) engages.

1. A door handle mechanism characterized in that, it consists of the following;
A motion shaft (1), which is the movement organ between the door handle (5) and the lock (8) and provides the movement of the tongue,
A cartridge (2), which supports the motion spring (10) and enables the door handle (5) to be mounted on the door (7),
A badge ring (4), which ensures to hide the cartridge (2) and provides visuality on the door (7),
A handle locking tab (6), which ensures that the door handle (5) is fixed in the installed position and cannot be removed,
An internal badge (9), which supports the movement spring (10) and enables the door handle to be supported,
A motion spring (10), which provides the pressure sensitivity and positioning of the door handle,
A spring cover (11) that provides fixation of the movement spring (10) and movement supporting and limitation to the door handle (5).
